(19) United States
(12) Patent Application Publication
(10) Pub. No.: US 2011/0201351 A1
(43) Pub. Date: Aug. 18, 2011

(54) SYSTEM AND METHOD FOR PROVIDING MOBILE USER CLASSFICATION INFORMATION FOR A TARGET GEOGRAPHICAL AREA

(75) Inventor: Yixiang Chen, Palo Alto, CA (US)

(73) Assignee: OPENWAVE SYSTEMS INC., Redwood City, CA (US)

(21) Appl. No.: 13/027,686

(22) Filed: Feb. 15, 2011

Related U.S. Application Data
(60) Provisional application No. 61/304,783, filed on Feb. 15, 2010.

(51) Int. Cl. H04W 24/00

(52) U.S. Cl. 455/456.1

(57) ABSTRACT

A system and method for providing mobile user classification information for a target geographical area uses location information of mobile communication devices to detect the mobile communication devices within the target geographical area at a specified time and then further uses at least one of the location information of the detected mobile communication devices and Internet session information of the detected mobile communication devices to produce the mobile user classification information of the mobile communication devices within the target geographical area that are classified in one or more classifications.

### CROSS-REFERENCE TO RELATED APPLICATION

This application is entitled to the benefit of provisional U.S. Patent Application Ser. No. 61/304,783, filed Feb. 15, 2010, which is incorporated herein by reference.

### BACKGROUND

Mobile communication devices are widely used among various user groups. Conventional mobile communication devices allow users to communicate with one another via voice, text, and multimedia messages. Also, many mobile communication devices allow users to access information available over the Internet. Thus, mobile communication devices increase the ability and the number of ways that people can communicate with each other.

With the wide use of mobile communication devices, there is a strong demand to provide services and advertisements to the users of these mobile communication devices. Various service providers and advertisers are particularly interested in directing their services and advertisements to targeted users of mobile communication devices. One of the ways to target services and advertisements to particular users of mobile communication devices is to use location information of the mobile communication devices to target users within a defined geographical area.

A concern with using location information of mobile device users is that privacy of the targeted users is typically not protected when the location information of the users are sent to the service providers, the advertisers and/or associated parties. Another concern with using location information of mobile device users is that a significant portion of the targeted mobile device users at the same geographical area may not be interested in the services and/or advertisements being promoted to them.

In view of the above concerns, there is a need for a system and method to more effectively target users of mobile communication devices without compromising the privacy of the targeted users.

### SUMMARY

A system and method for providing mobile user classification information for a target geographical area in accordance with embodiments of the invention uses location information of mobile communication devices to detect the mobile communication devices within the target geographical area at a specified time and then further uses at least one of the location information of the detected mobile communication devices and Internet session information of the detected mobile communication devices to produce the mobile user classification information of the mobile communication devices within the target geographical area that are classified in one or more classifications.

A system for providing mobile user classification information for a target geographical area in accordance with an embodiment of the invention comprises a location storage module, an Internet session storage module and a data processing engine. The location storage module is configured to receive and store location information of mobile communication devices associated with a mobile network. The Internet session storage module is configured to receive and store Internet session information of at least some of the mobile communication devices that have accessed the Internet via the mobile network. The data processing engine is configured to select the mobile communication devices that were within the target geographical area at a particular time using the location information stored in the location storage module in response to a request for the mobile user classification information for one or more classifications, the target geographical area and the particular time. The data processing engine is further configured to produce the mobile user classification information of the selected mobile communication devices that are classified in the one or more classifications. The one or more classifications are dependent on at least one of the location information of the selected mobile communication devices stored in the location storage module and the Internet session information of the selected mobile communication devices stored in the Internet session storage module. The system may further include an analytics engine configured to classify the mobile communication devices into detected classifications based on the location information stored in the location storage module and the Internet session information stored in the Internet session storage module.

A method for providing mobile user classification information for a target geographical area in accordance with an embodiment of the invention comprises receiving location information of mobile communication devices associated with a mobile network, storing the location information in a first storage device, receiving Internet session information of at least some of the mobile communication devices that have accessed the Internet via the mobile network, storing the Internet session information in a second storage device, selecting the mobile communication devices that were within the target geographical area at a particular time using the location information stored in the first storage device in response to a request for the mobile user classification information for one or more classifications, the target geographical area and the particular time, and producing the mobile user classification information of the selected mobile communication devices that are classified in the one or more classifications, the one or more classifications being dependent on at least one of the location information of the selected mobile communication devices and the Internet session information of the selected mobile communication devices.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a mobile communication network that includes a mobile user classification and service delivery (MUCSD) system in accordance with an embodiment of the invention.

FIG. 2 is another block diagram of the mobile communication network, which shows components of the MUCSD system in accordance with an embodiment of the invention.

FIG. 3 is a process flow diagram of the operation of an analytics engine of the MUCSD system in accordance with an embodiment of the invention.

FIG. 4 is a process flow diagram of the operation of a geo-fence engine of the MUCSD system in accordance with an embodiment of the invention.

FIG. 5 is a flow diagram of a method for providing mobile user classification information within a target geographical area in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

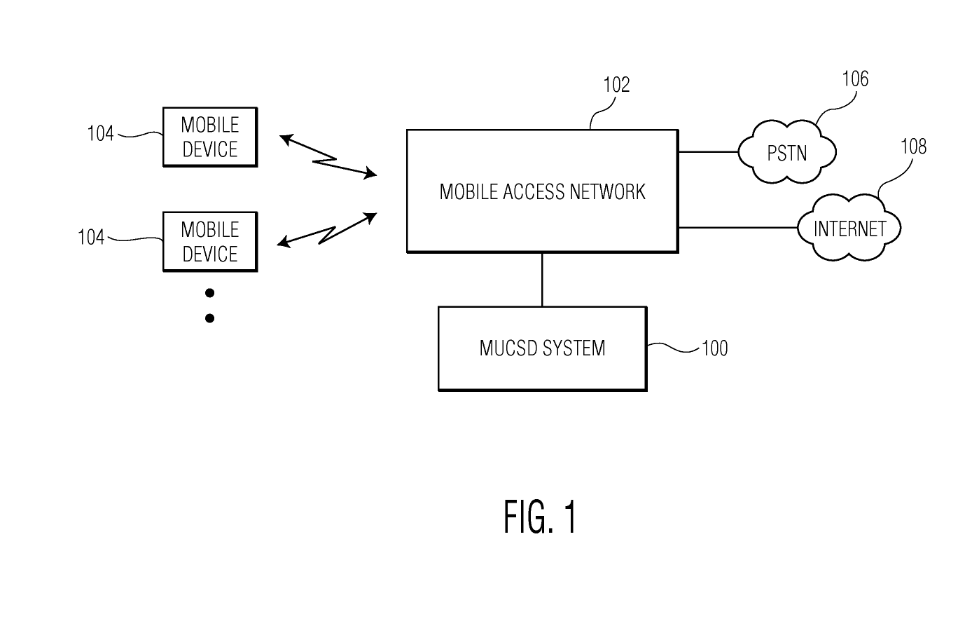

Turning now to FIG. 1, a mobile communication network that includes a mobile user classification and service delivery (MUCSD) system 100 in accordance with an embodiment of the invention is shown. As shown in FIG. 1, the mobile communication network includes a mobile access network 102, which allows mobile communication devices 104 to access the public switched telephone network (PSTN) 106 and/or the Internet 108 via the mobile access network. The mobile access network may also be connected to other networks (not shown), such as private telephone networks and/or data networks. In the illustrated embodiment, the MUCSD system is connected to the mobile access network. As described in more detail below, the MUCSD system operates to receive physical geographical location information and Internet session information of the mobile communication devices, which are then used to classify the users of the mobile communication devices in one or more classifications and to provide mobile user classification information with respect to a target geographical area to a requesting party without revealing identity information of the mobile users. Thus, the MUCSD system is able to provide important mobile user information for targeted services and/or advertisements while protecting the privacy of the mobile users. As used herein, the mobile user classification information is any information related to classifications of mobile users based on the location and Internet session information, which can include current and/or historical information.

The mobile access network 102 can be any type of a mobile access network, such as a Universal Mobile Telecommunication System (UMTS) network or a CDMA2000 network, which provides communication services for the mobile communication devices 104. The mobile communication devices are wireless mobile devices that are subscribed to the communication services of the mobile access network. The mobile communication devices can be any type of wireless mobile devices, such as cell phones, smartphones, personal digital assistants (PDAs) and netbooks. The mobile communication devices are described herein as being Internet-enabled devices. Thus, the mobile communication devices can access the Internet via the mobile access network. Consequently, Internet session information of the mobile communication devices is available at the mobile access network. However, some of the mobile communication devices may not be Internet-enabled devices, which means that these devices would not be accessing the Internet via the mobile access network.

In operation, the mobile access network 102 extracts physical geographical location information of the mobile communication devices 104 using one or more of known locating methods. If the mobile communication devices are equipped with Global Positioning System (GPS), the mobile access network receives the location information, such as latitude, longitude and altitude, from the GPS of the mobile communication devices. If the mobile communication devices are not equipped with GPS, the mobile access network may employ other locating methods to determine the locations of the mobile communication devices. Thus, location information of the mobile communication devices is available at the mobile access network even if some or all of the mobile communications devices are not equipped with GPS.

The MUCSD system 100 operates to receive the location information and/or the Internet session information of the mobile communication devices 104 from the mobile access network 102. The MUCSD system stores the location information and the Internet session information to maintain historical location information and historical Internet session information for each of the mobile communication devices. The MUCSD system uses the stored location information and/or the stored Internet session information to classify the users of the mobile communication devices in one or more classifications to produce mobile user classification information for a target geographical area at a particular time and provides the mobile user classification information without revealing identity information of any mobile users to a requesting party, which may be a service provider, an advertiser or a party associated with one or more services providers and advertisers.

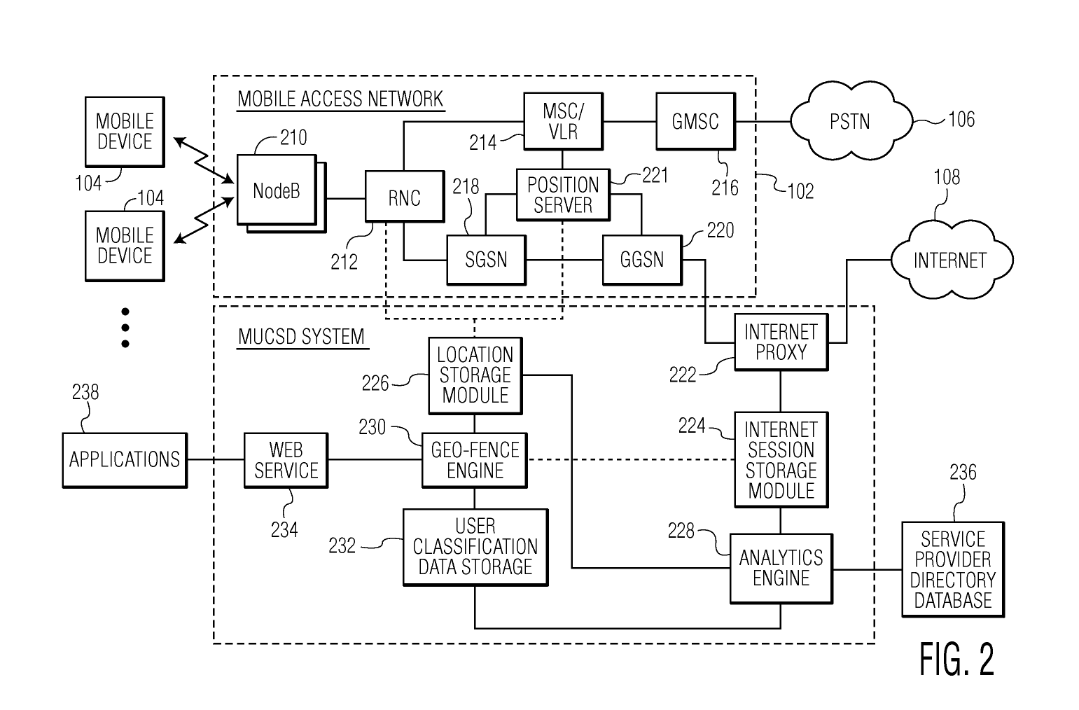

The MUCSD system 100 is described in more detail with reference to FIG. 2, which shows the components of the MUCSD system in accordance with an embodiment of the invention. In FIG. 2, the mobile access network 102 is shown as being a UMTS network. However, in other embodiments, the mobile access network 102 may be another type of mobile access network, such as a Code-Division Multiple Access (CDMA), Wideband-CDMA (W-CDMA), Global System for Mobile communication (GSM) or Long Term Evolution (LTE) network. As shown in FIG. 2, the UMTS network includes NodeBs 210, a Radio Network Controller (RNC) 212, a mobile switching center/visitor location register (MSC/VLR) 214, a gateway mobile switching center (GMSC) 216, a Serving General Packet Radio Service (GPRS) Support Node (SGSN) 218, and a Gateway GPRS Support Node (GGSN) 220. The UMTS network may also include a position server 221, which locates the mobile communication devices 104 to acquire location information of the devices. The position server 221 usually requests user consent before locating the mobile communication device of the user. These components of the UMTS network are well-known components, and thus, are not described herein in detail.

The MUCSD system 100 exploits two attributes of the UMTS network 102 to build and provide mobile user classification information. The first attribute of the UMTS network is that the UMTS network performs location update procedures for the mobile communication devices within its network. A mobile communication device must attach to a cell to start a user session, such as a telephone call or an Internet usage. The mobile communication device also needs to work with the UMTS network in concert to ensure uninterrupted user session when the device changes its location. Even when the mobile device is not engaged in an active session, the mobile device still needs to communicate with components of the UMTS network, such as one of the NodeBs 210 and RNC 212, to perform location update procedures in order to maintain service. Thus, the MUCSD system can have access to real-time mobile user location data by intercepting or listening location management information delivered on the UMTS network or requesting the location information from the UMTS network. In addition, by analyzing mobile devices' movements over a certain period of time, the MUCSD system can build user classifications based on location histories of the users' mobile devices. The second attribute of the UMTS network is that when a mobile communication device is accessing the Internet through the GGSN 220 (or an enhanced RNC) in the UMTS network, the UMTS network must know the precise destination address and session type on the Internet in order to establish the data session between the mobile communication device and the Internet end-point. Thus, the MUCSD system can have access to Internet session information of the mobile communication devices via the UMTS network. Consequently, by cataloguing users' Internet usage patterns over a period of time, the MUCSD system can discover, create and assign a set of classifications to the mobile users. The MUCSD system can also incorporate a service provider's customer records into the classification process. Using the location information and/or the Internet usage information of the mobile communication devices, the MUCSD system is able to build and provide mobile user classification information, as described below.

Using the location information, the Internet session information and the classifications of the mobile communication devices 104, the MUCSD system 100 can then provide user classification information within a target geographical area for a particular time, which can be an instantaneous time or a period of time. The following table provides an example of the MUCSD system output.

10 AM, February 11, 2010, Fisherman's Wharf and surrounding area,
San Francisco

| User Classification | Number of Users |
|---|---|
| Facebook Users | 400 |
| Sports Fans | 600 |
| Victorian Secrets Web Site Users | 150 |
| Users that are out-of-towners | 200 |
| Users that skied last weekend | 180 |

As described in more detail below, the MUCSD system 100 can provide the above mobile user classification information to applications, such as mobile advertising applications, without revealing any of the mobile users' personally identifiable information and actual geographical coordinates. On the other hand, applications can still reach end users through the MUCSD system because the MUCSD system maintains the user identity information of the mobile communication devices counted in the mobile user classification information.

As shown in FIG. 2, the MUCSD system includes an Internet proxy 222, an Internet session storage module 224 and a location storage module 226. The Internet proxy is positioned along the data path between the UMTS network 102 and the Internet 108. In FIG. 2, the Internet proxy is shown to be positioned between the UMTS network and the Internet. However, in other embodiments, the Internet proxy may be located within the UMTS network along the data path, as a separate component or integrated into an existing component of the UMTS network. As an example, the Internet proxy may be a separate hardware positioned between the SGSN 218 and the GGSN 220. As another example, the Internet proxy may be integrated into the RNC 212. The Internet proxy interfaces between the mobile communication devices 104 and the Internet to monitor data traffic. When the Internet proxy receives an Internet request from a mobile communication device, e.g., a hypertext transfer protocol (HTTP) request, the Internet proxy sends a copy of the Internet request to the Internet session storage module 224 and sends the original Internet request to the Internet. The Internet proxy also monitors the Internet session of the mobile communication device and sends the Internet session information to the Internet session storage module. The Internet session information stored in the Internet session storage module may include user identifier, such as Mobile Subscriber Integrated Services Digital Network Number (MSISDN) or International Mobile Subscriber Identity (IMSI), Internet Protocol (IP) destination and origin addresses, Universal Resource Identifier (URI), device capabilities, content type, codec type, bit rte, session duration, client type, network elements responsible for creating/maintaining the Internet session, and other data related to the Internet session. The Internet session storage module stores the copy of the Internet request and other Internet session information. The Internet session storage module includes any type of memory, such as a cache, a random access memory (RAM) or a hard drive memory. Thus, the Internet session storage module can be viewed as a storage device. The Internet proxy may be implemented as software executed by a processor of any type, hardware, firmware or any combination thereof.

The location storage module 226 operates to estimate the physical geographical locations of the mobile communication devices 104 using location information of the mobile communication devices from the UMTS network 102. The location information from the UMTS network may include user identifier, such as MSISDN or IMSI, geographical coordinates, horizontal and vertical uncertainties, horizontal and vertical speed, heading (or direction), cell identification, cell type, such as CDMA, W-CDMA, GSM, UMTS, LTE, WiFi, etc., positioning technology capabilities, position technology utilized, network elements responsible for determining the location, and other information related to the location information of the mobile communication devices. In some embodiments, the location storage module may be configured to acquire some or all of the location information by receiving location update messages from the UMTS network, for example, from the RNC 212 of the UMTS network, or from a network probe monitoring the UMTS network. In other embodiments, the location storage module may actively request and receive the location information of the mobile communication devices from the UMTS network, for example, from the position server 221 of the UMTS network. The location storage module estimates the locations of the mobile communication devices using the received location information. The location storage module then stores the device location estimates. Thus, similar to the Internet session storage module, the location storage module includes any type of memory, such as a cache, a RAM or a hard drive memory. Consequently, the location storage module can also be viewed as a storage device. The functionalities of the location storage module may be implemented as software executed by a processor of any type, hardware, firmware or any combination thereof.

As shown in FIG. 2, the MUCSD system 100 further includes an analytics engine 228, a geo-fence engine 230, a user classification data storage 232 and a web service 234. The analytics engine is a data processing engine configured to classify mobile users using at least one of location information and Internet session information of the users' mobile communication devices. The analytics engine is connected to the Internet session storage module 224 and the location storage module 226 to receive the Internet session information from the Internet session storage module and the location information including location estimates from the location storage module. The analytics engine is also connected to a service provider directory database 236 to receive customer records of the interested mobile communication devices. The analytics engine then uses the received information to classify the mobile users to known classifications or new classifications, which may be detected/created depending on the received information. The analytics engine then stores the mobile user classifications in the user classification data storage 232, which includes any type of memory, such as a RAM or a hard drive memory. The analytics engine may be implemented as software executed by a processor of any type, hardware, firmware or any combination thereof.

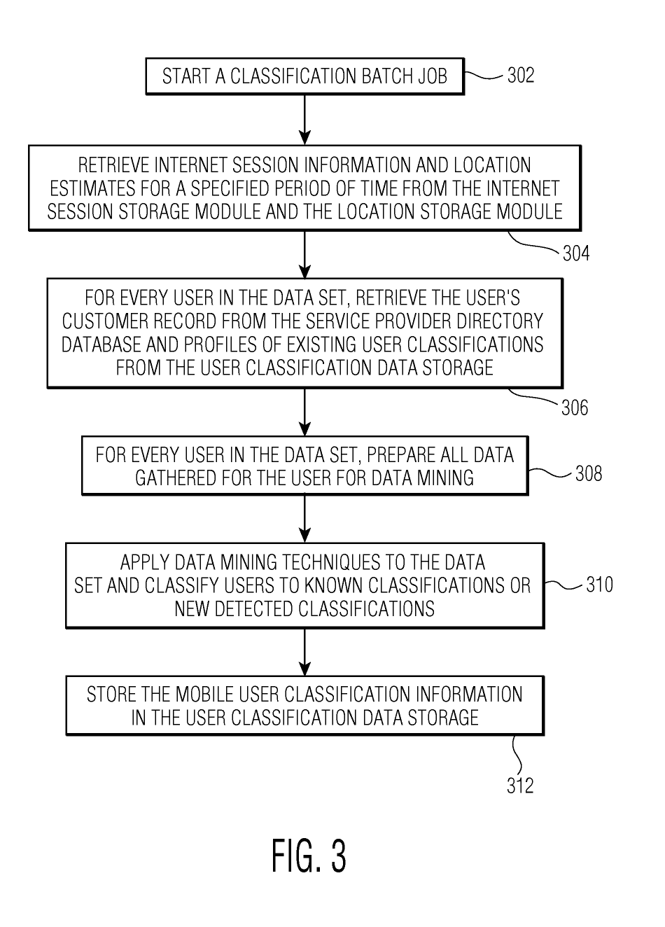

The analytics engine 228 is described in more detail with reference FIG. 3, which shows a process flow diagram of the operation of the analytics engine in accordance with an embodiment of the invention. At block 302, the analytics engine starts a classification batch job. At block 304, the analytics engine retrieves Internet session information and location estimates for a specified period of time from the Internet session storage module 224 and the location storage module 226. At block 306, for every user in the data set, the analytics engine also retrieves the user's customer record from the service provider directory database and profiles of existing user classifications from the user classification data storage.

Next at block 308, for every user in the data set, the analytics engine 228 prepares all data gathered for the user for data mining. At block 310, the analytics engine applies data mining techniques to the data set and classifies users to known classifications or new detected classifications. The data mining techniques employed by the analytics engine may include classification analysis, association analysis and cluster analysis. The data mining techniques are used to detect patterns in the gathered data with respect to location and Internet session information to classify the different mobile users. For example, by analyzing that a mobile user has higher-than-average visits to football related web-sites and content even during the off-season period, the analytics engine can classify this mobile user as a “die-hard football fan.”Next, at block 312, the analytics engine stores the mobile user classification information in the user classification data storage. The analytics engine may repeatedly perform the classification batch job on a predefined schedule to update the mobile user classifications.

The geo-fence engine 230 is another data processing engine that is configured to provide mobile user classification information as a response to a request from a requesting party for user classification information for a target geographical area and a specified time with respect to one or more classifications. In the illustrated embodiment, a request for user classification information within a target area is made using applications 238, which may be web browsers or other applications for sending and receiving data, connected to the web service 234. The mobile user classification information may include a count of a classification in a geographical area, counts of multiple classifications in a geographical area, highest and average counts of classifications in a geographical area, anonymized and temporal (both in space and time) user identifications within each classification and any other information related to the requested classifications without revealing user identity information. The geo-fence engine filters out or selects mobile communication devices that were within the requested target geographical area at the specified time. The requested target area may be an area within or outside of a geo-fence area, which is a geographical boundary area having any shape, such as a circular shape, a polygonal shape, an elliptical shape, etc. Depending on the requested classifications, the geo-fence engine uses information stored in the Internet session storage module 224, the location storage module 226 and/or the user classification data storage 232 to provide the mobile user classification for the requested classifications. If a requested classification is a known classification, the mobile user classification information stored in the user classification data storage is used to supply the requested information. In addition, the geo-fence engine may use the latest Internet session and location information stored in the Internet session storage module and the location storage module to supplement the classification information stored in the user classification data storage with new or updated classification information. The latest Internet session and location information is the information not processed by the analytics engine during the last classification procedure. If a requested classification is not a known classification, the geo-fence engine uses the Internet session and location information stored in the Internet session storage module and the location storage module to perform an on-the-fly classification procedure using the requested classification to provide the requested user classification information. That is, for each mobile communication device that was in the target area at the specified time, the geo-fence engine analyzes the Internet session and location information for that mobile device to determine if the mobile device can be classified in the requested classification. The geo-fence engine may be implemented as software executed by a processor of any type, hardware, firmware or any combination thereof.

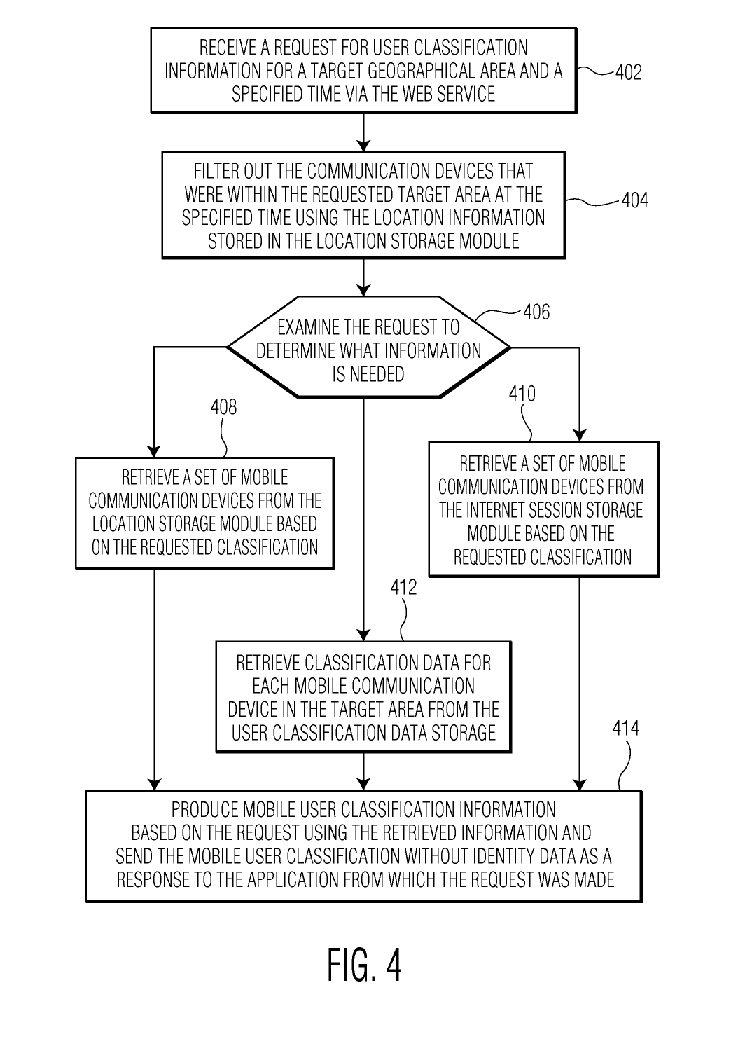

The geo-fence engine 230 is described in more detail with reference FIG. 4, which shows a process flow diagram of the operation of the geo-fence engine in accordance with an embodiment of the invention. At block 402, the geo-fence engine receives a request for user classification information for a target geographical area and a specified time via the web service. At block 404, the geo-fence engine filters out the mobile communication devices that were within the requested target area at the specified time using the location information stored in the location storage module 226.

Next, at block 406, the geo-fence engine 230 examines the request to determine what information is needed to fulfill the request. That is, the geo-fence engine examines the request to determine whether the historical Internet session information stored in the Internet session storage module 224, the historical location information stored in the location storage module 226 and/or the historical classification data stored in the user classification data storage 232 are needed. If the historical location information, such as user location history, is needed, the geo-fence engine retrieves a set of mobile communication devices from the location storage module based on the requested classification, at block 408. If the historical Internet session information, such as Internet browsing history, is needed, the geo-fence engine retrieves a set of mobile communication devices from the Internet session storage module based on the requested classification, at block 410. If the historical classification data is needed, the geo-fence engine retrieves classification data for each mobile communication device in the target area from the user classification data storage, a block 412. Thus, the geo-fence engine retrieves only the information needed to fulfill the request. As an example, if the request is for one or more known classifications, then the geo-fence engine retrieves only the information from the user classification data storage. As another example, if the request is for a new or unknown classification related only to historical Internet usages, then the geo-fence engine retrieves only the information from the Internet session storage module. As another example, if the request is for a new or unknown classification related only to historical locations, then the geo-fence engine retrieves only the information from the location storage module. However, if the request is for a new or unknown classification related to both historical locations and Internet usages, then the geo-fence engine retrieves the information from the location storage module and the Internet session storage module.

At block 414, the geo-fence engine 230 produces mobile user classification information based on the request using the retrieved information and sends the mobile user classification information without identity data as a response to the application 238 from which the request was made. As an example, the mobile user classification information may include counts of mobile communication devices without identity data for each requested classification for a target geographical area at a specified time. Thus, the privacy of the mobile users is not compromised when the mobile user classification information is provided to the requesting party. However, since the user identities of the mobile communication devices counted in the mobile user classification information are known to the MUCSD system 100, the requesting party can target those mobile communication devices for services and/or advertisements via the MUCSD system even though the requesting party is not exposed to the user identify information of the mobile communication devices.

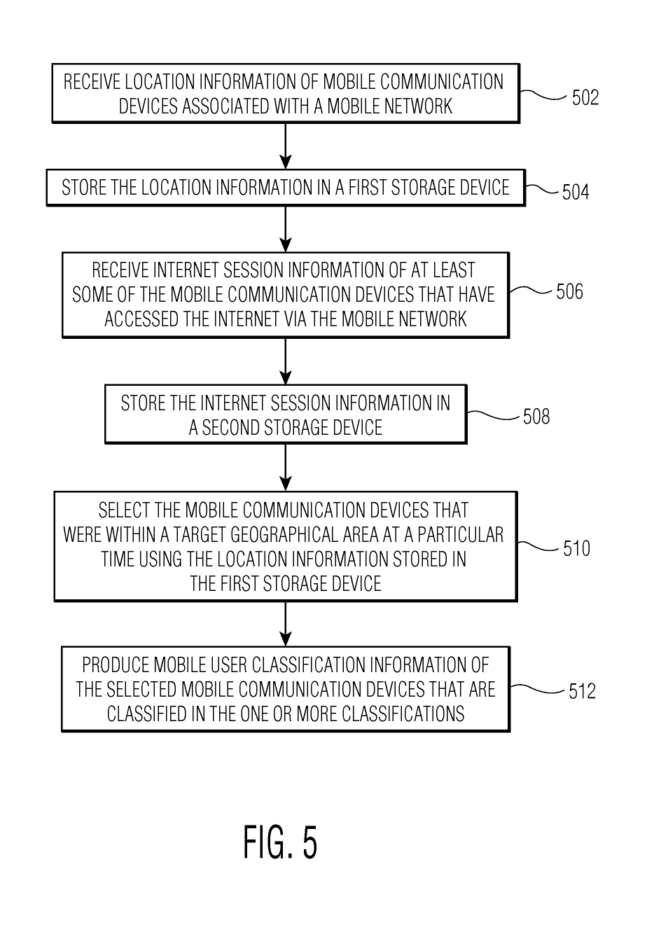

A method for providing mobile user classification information within a target geographical area in accordance with an embodiment of the invention is described with reference to a flow diagram of FIG. 5. At block 502, location information of mobile communication devices associated with a mobile network is received. At block 504, the location information is stored in a first storage device. At block 506, Internet session information of at least some of the mobile communication devices that have accessed the Internet via the mobile network is received. At block 508, the Internet session information is stored in a second storage device. At block 510, the mobile communication devices that were within the target geographical area at a particular time are selected using the location information stored in the location storage module in response to a request for the mobile user classification information for one or more classifications, the target geographical area and the particular time. At block 512, the mobile user classification information of the selected mobile communication devices that are classified in the one or more classifications is produced. The one or more classifications are dependent on at least one of the location information of the selected mobile communication devices and the Internet session information of the selected mobile communication devices.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for providing mobile user classification information for a target geographical area, the system comprising:
a location storage module configured to receive and store location information of mobile communication devices associated with a mobile network;
an Internet session storage module configured to receive and store Internet session information of at least some of the mobile communication devices that have accessed the Internet via the mobile network; and
a data processing engine configured to select the mobile communication devices that were within the target geographical area at a particular time using the location information stored in the location storage module in response to a request for the mobile user classification information for one or more classifications, the target geographical area and the particular time, the data processing engine being further configured to produce the mobile user classification information of the selected mobile communication devices that are classified in the one or more classifications, the one or more classifications being dependent on at least one of the location information of the selected mobile communication devices stored in the location storage module and the Internet session information of the selected mobile communication devices stored in the Internet session storage module.

2. The system of claim 1, wherein the data processing engine is configured to produce a count of the mobile communication devices that are classified in a particular classification of the one or more classifications.

3. The system of claim 2, wherein the data processing engine is configured to provide the count of the mobile user classification information without providing any identity information of the mobile communication devices.

4. The system of claim 1, further comprising an analytics engine configured to classify the mobile communication devices into detected classifications based on the location information stored in the location storage module and the Internet session information stored in the Internet session storage module.

5. The system of claim 4, wherein the analytics engine is configured to apply one or more data mining techniques to classify some of the mobile communication devices to known classifications or a new classification detected using the one or more data mining techniques.

6. The system of claim 4, wherein the analytics engine is configured to retrieve customer records of the mobile communication devices for classification consideration.

7. The system of claim 1, wherein the location storage module is configured to receive the location information of the mobile communication devices from the mobile network.

8. The system of claim 7, wherein the location storage module is configured to receive a location update message from the mobile network.

9. The system of claim 1, further including an Internet proxy that monitors data traffic between the mobile communication devices and the Internet to provide the Internet session information to the Internet session storage module.

10. A method for providing mobile user classification information for a target geographical area, the method comprising:
receiving location information of mobile communication devices associated with a mobile network;
storing the location information in a first storage device;
receiving Internet session information of at least some of the mobile communication devices that have accessed the Internet via the mobile network;
storing the Internet session information in a second storage device;
selecting the mobile communication devices that were within the target geographical area at a particular time using the location information stored in the first storage device in response to a request for the mobile user classification information for one or more classifications, the target geographical area and the particular time; and
producing the mobile user classification information of the selected mobile communication devices that are classified in the one or more classifications, the one or more classifications being dependent on at least one of the location information of the selected mobile communication devices and the Internet session information of the selected mobile communication devices.

11. The method of claim 10, wherein the producing includes producing a count of the mobile communication devices that are classified in a particular classification of the one or more classifications.

12. The method of claim 11, wherein the producing includes providing the count of the mobile user classification information without providing any identity information of the mobile communication devices.

13. The method of claim 10, further comprising classifying the mobile communication devices into detected classifications based on the location information stored in the first storage device and the Internet session information stored in the second storage device.

14. The method of claim 13, wherein the classifying includes applying one or more data mining techniques to classify some of the mobile communication devices to known classifications or a new classification detected using the one or more data mining techniques.

15. The method of claim 14, wherein the classifying includes retrieving customer records of the mobile communication devices for classification consideration.

16. The method of claim 10, wherein the receiving the location information includes receiving the location information of the mobile communication devices from the mobile network.

17. The method of claim 16, wherein the receiving the location information includes receiving a location update message from the mobile network.

18. The method of claim 10, wherein the receiving the Internet session information includes monitoring data traffic between the mobile communication devices and the Internet using an Internet proxy to provide the Internet session information to the second storage device.

19. A system for providing mobile user classification information for a target geographical area, the system comprising:
a location storage module configured to receive and store location information of mobile communication devices associated with a mobile network;
an Internet session storage module configured to receive and store Internet session information of at least some of the mobile communication devices that have accessed the Internet via the mobile network;
an analytics engine configured to classify the mobile communication devices into detected classifications based on the location information stored in the location storage module and the Internet session information stored in the Internet session storage module; and
a geo-fence engine configured to select the mobile communication devices that were within the target geographical area at a particular time using the location information stored in the location storage module in response to a request for the mobile user classification information for one or more classifications, the target geographical area and the particular time, the geo-fence engine being further configured to produce the mobile user classification information of the selected mobile communication devices that are classified in the one or more classifications, the one or more classifications being dependent on at least one of the location information of the selected mobile communication devices stored in the location storage module and the Internet session information of the selected mobile communication devices stored in the Internet session storage module.

20. The system of claim 1, wherein the geo-fence engine is configured to provide a count of the mobile communication devices that are classified in a particular classification of the one or more classifications.
